(19) United States
(12) Patent Application Publication
(10) Pub. No.: US 2014/0197256 A1
(43) Pub. Date: Jul. 17, 2014

(54) DEVICE AND METHOD FOR CHOPPING ORGANIC MATTER

(71) Applicants: Edward Boes, Blacksburg, VA (US); Katie Boes, Blacksburg, VA (US); LuVerne Boes, Hermosa, SD (US); Lillian Boes, Hermosa, SD (US)

(72) Inventors: Edward Boes, Blacksburg, VA (US); Katie Boes, Blacksburg, VA (US); LuVerne Boes, Hermosa, SD (US); Lillian Boes, Hermosa, SD (US)

(21) Appl. No.: 13/740,196

(22) Filed: Jan. 12, 2013

(51) Int. Cl. B02C 18/00; B26B 17/00

(52) U.S. Cl. CPC B02C 18/0084; B26B 17/00
USPC 241/28; 30/303; 269/289 R

(57) ABSTRACT

A device and method for chopping organic matter includes a chopping device consisting of a handle and a plurality of flat, sharpened blades attached radially around one end of the handle's axis; a chopping board, which acts as a chopping surface and conforms to the inside, bottom shape of a containment vessel; and the containment vessel, which stores, contains, and transports organic matter for chopping and handling. The chopping board is placed on the inside bottom surface of the containment vessel, organic matter is placed into the containment vessel and on top of the chopping board, and the chopping device is placed inside the containment vessel. The chopping device is repeatedly thrust downward, chopping the organic matter between the chopping board and the chopping device. Embodiments of the chopping device and the chopping board may be scaled proportionally to fit predetermined sizes of containment vessels.

### CROSS-REFERENCE TO RELATED APPLICATIONS:

This application claims the benefit of PPA Ser. No. 61/586,684, filed Jan. 13, 2012 by the present inventors, the contents of which are incorporated by reference.

### FEDERALLY SPONSORED RESEARCH OR DEVELOPMENT

none

### REFERENCE TO SEQUENCE LISTING

none

### BACKGROUND

1. Field

This application relates to the technical field of tools used in association with composting, specifically to a compost processing tool which is effective in chopping organic matter prior to composting.

2. Prior Art

The use of composting to turn organic matter into a valuable resource is an ever expanding field as more people become aware of the environmental and economic benefits of composting. Many municipalities encourage citizens to keep active compost bins as a way to reduce kitchen waste and decrease the dependence on synthetic soil amendments when gardening. These bins have been proven fast and effective at decomposing various organic matter.

Although current composting practices have been proven effective, the efficiency, quality and rate of composting can be increased by chopping the organic matter into smaller, uniform pieces prior to introduction to the compost bins. This is especially important when composting with enclosed bins, composting barrels, or when practicing Vermicomposting. The time consuming task of routinely hand-cutting kitchen scraps into smaller pieces prior to composting can be avoided altogether, by containing a whole batch of large scraps to be processed at one time. There exists a need to provide the user an arrangement of devices for the chopping of organic matter prior to introduction to compost bins.

Current devices used to chop organic matter into smaller pieces before introduction to a compost pile use large mechanical systems, rely on electrical power, or do not provide adequate chopping. For instance, U.S. Pat. No. 5,413,287 to Telsnig (1995) is a chopper for household and garden waste. The large size and reliance on a power source to drive the rotary chopping blades makes this an impractical device for everyday home use. U.S. Pat. No. 7,431,231 to Saiki (2008) is reliant on electrical power, making use impractical in most gardens, and produces results that are shredded rather than chopped. Shredded compost can prevent air from freely moving throughout the compost, hindering the composting process and leading to inefficiencies. Since both of these examples utilize power sources other than human effort, their appeal to “green-concious” gardeners is also diminished.

Other devices designed for composting focus more on agitation of the compost pile, rather than the ease of chopping newly introduced organic matter. For instance, U.S. Pat. No. 5,382,065 to Snell (1995) incorporates a single cutting blade that when thrust into the compost pile, cuts the organic matter, then subsequently pivots to aid in stirring the compost. A large emphasis is placed on the stirring attributes of the device, rather than the cutting attributes. With this device, cutting large amounts of organic matter will produce inconsistent results and prove to be time-consuming. U.S. Pat. No. 5,263,253 to Sainsbury (1993) describes a tool with a single blade suitable for chopping, cutting, and turning compost. Chopping and cutting is achieved by thrusting the blade into the pile, which will produce inconsistently chopped pieces and prove to be time-consuming. Both of these examples rely on the organic matter being in the compost pile during chopping. This increases the chances of damaging compost bins, which are frequently made of plastic and often not in a suitable position for efficient and forceful chopping.

### SUMMARY

In accordance with one embodiment a device and method for users to chop organic matter into smaller pieces comprises a chopping device with a plurality of blades at the end of a single handle, a chopping board, and a containment vessel. The chopping device has a number of sharpened chopping blades surrounding the axis of a handle. The chopping board serves as a rigid, flat surface for the chopping device to strike when chopping the organic matter, and as a barrier to protect the bottom of the containment vessel when the chopping device is used. The containment vessel acts as a way of holding the organic matter in a compact place for efficient chopping, and as a way to hold and transport the organic matter before and after chopping. The blades, the chopping board, and the containment vessel all work together in combination with the users downward thrusts to chop organic matter into smaller pieces prior to its addition to a compost pile.

### DRAWINGS—FIGURES

FIG. 1 is a perspective view of a potential embodiment of a chopping device, a potential embodiment of a chopping board, and a potential embodiment of a containment vessel;

FIG. 2 is section view of embodiments showing intended use;

FIG. 3 is a perspective view of one embodiment of a chopping device;

FIG. 4 is an exploded view of one embodiment of a chopping device;

FIG. 5A is a front view of one embodiment of a chopping blade;

FIG. 5B is an end view of one embodiment of a chopping blade;

FIG. 6 is a perspective view of one embodiment of a chopping board;

FIG. 7A to 7C show alternate embodiments of a chopping device;

FIG. 8 is a perspective view of an alternate embodiment of a chopping board;

DRAWINGS-REFERENCE NUMERALS

| | |
|---|---|
| 11 | chopping device |
| 12 | chopping board |
| 13 | containment vessel |
| 14 | organic matter |
| 15 | handle |
| 16 | blade |
| 17 | blade |
| 18 | blade |
| 19 | blade |
| 20 | hub |
| 21 | fastening device |
| 22 | matching hole |
| 23 | straight notch |
| 24 | upper curved edge |
| 25 | lower curved edge |
| 26 | sharpened edge |
| 27 | outer edge |
| 28 | angle |
| 29 | notch |
| 30 | three blade chopping device |
| 31 | five blade chopping device |
| 32 | six blade chopping device |

### DETAILED DESCRIPTION

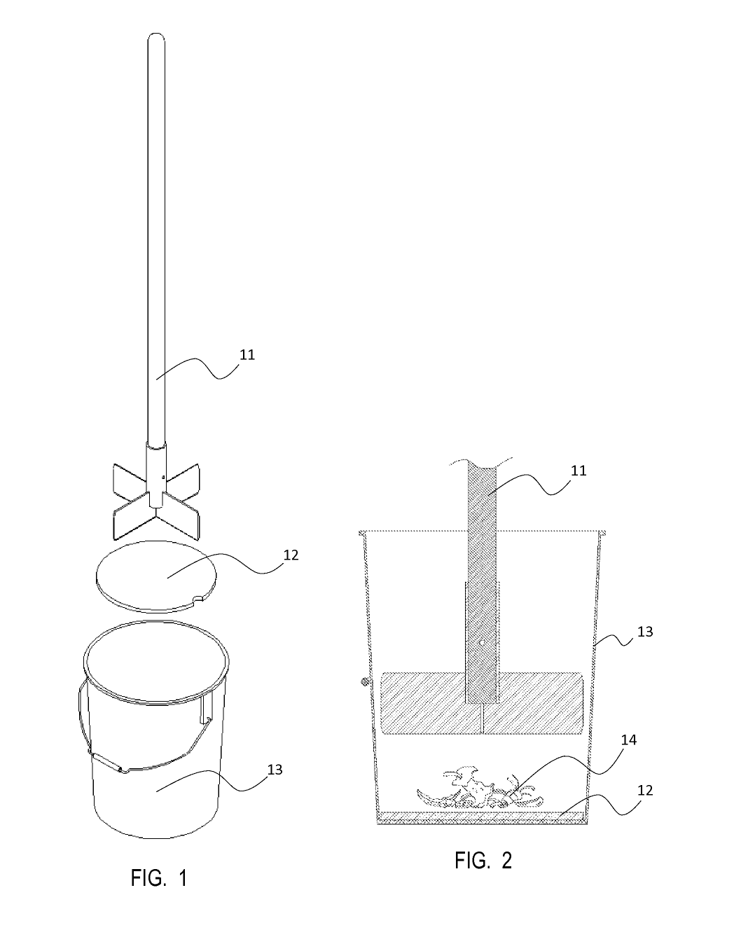

### First Embodiment—FIGS. 1 to 6

FIG. 1 is a perspective view of embodiments comprised of an embodiment of a chopping device 11, and embodiment of a chopping board 12, and an embodiment of a containment vessel 13.

FIG. 2 is a cross-section view of the embodiments in a possible configuration in which an organic matter 14 is to be chopped into smaller pieces. The chopping board 12 is placed inside the containment vessel 13. The organic matter 14 is placed inside the containment vessel 13 and on top of the chopping board 12. The chopping device 11 is placed inside the containment vessel 13 and with quick, firm strokes, chops the organic matter 14 between the chopping board 12 and the chopping device 11.

In further detail and still referring to FIG. 2, note the size relationships between the chopping board 12, the inside bottom of the containment vessel 13, and the chopping device 11. The chopping board 12 has an overall diameter conforming to and slightly smaller than the interior diameter of the bottom of the containment vessel 13. The diameter of the chopping board 12 is sized to allow insertion and removal within the containment vessel 13. The overall width of the chopping device 11 is no larger than the overall diameter of the chopping board 12. Note that there is now little space between the sides of the containment vessel 13 and the width of the chopping device 11.

In further detail of the containment vessel 13 of FIG. 2, the preferred size and shape for the containment vessel 13 is that of a standard five-gallon bucket. Other embodiments of the containment vessel 13 are possible and will respectively require changes in dimension to the chopping device 11 and the chopping board 12.

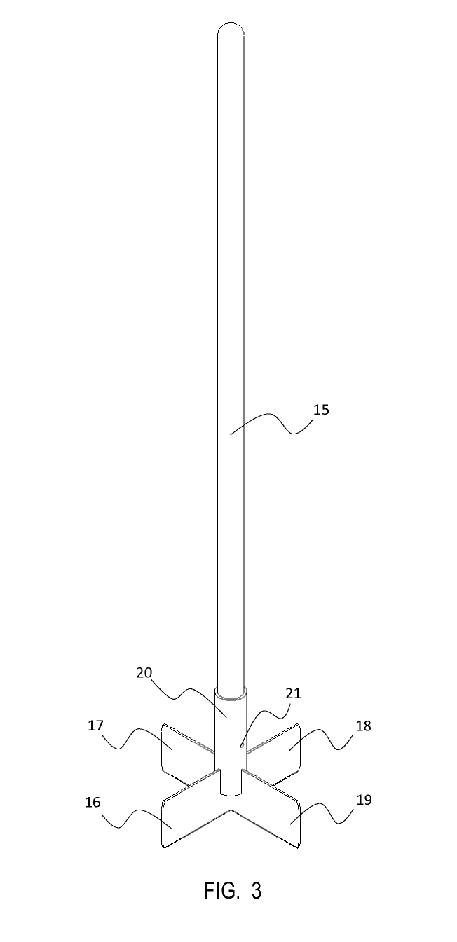

FIG. 3 is a perspective view of an embodiment of the chopping device 11 of FIG. 1. This embodiment consists of a handle 15, a plurality of blades 16,17,18,19, a center hub 20, and a fastening device 21. In further detail, the handle 15 is of sufficient height to allow the user to grasp the device in a low position, all the way up to a standing position. The handle 15 can be made of wood, plastic, metal, composite, or any other material of suitable strength.

Note that FIG. 3 shows a preferred embodiment of the chopping device 11. The plurality of blades 16,17,18,19 is in the most efficient configuration for use and manufacture.

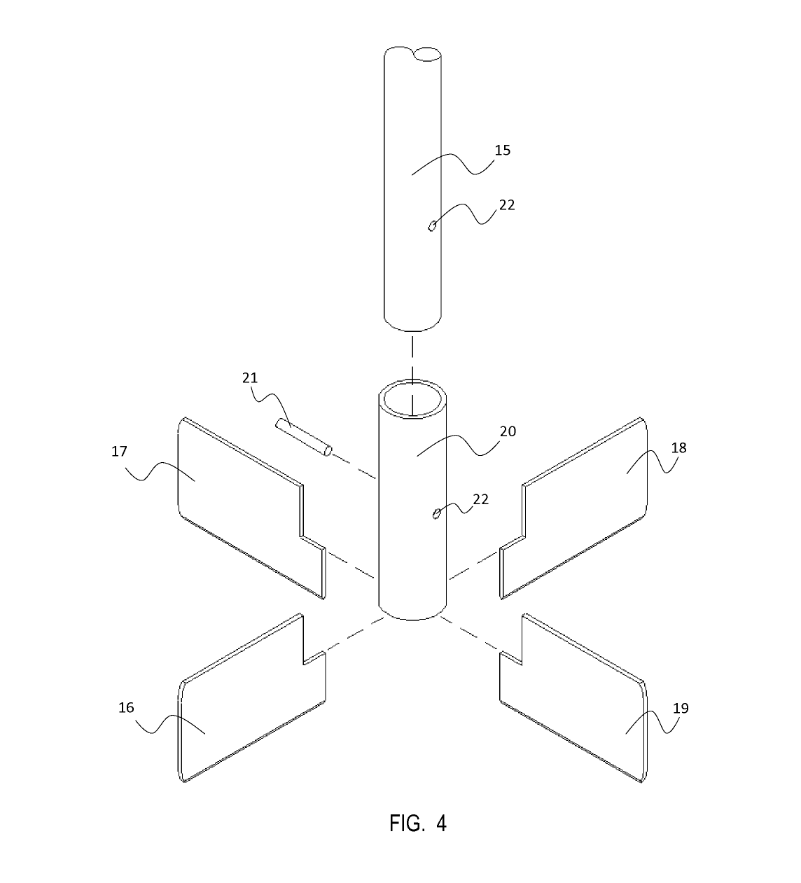

FIG. 4 is an exploded perspective view of the chopping device 11 detailed in FIG. 3 (complete handle not shown to allow more detailed view). The handle 15 is pressed tightly into the hub 20 and secured with a fastening device 21. The fastening device 21 fits into the matching hole 22 in the handle 15 and the hub 20. The fastening device 21 can be a rivet, pin, dowel, bolt, or any other method of mechanical fastening. The hub 20 is made of steel, cast-iron, or other suitable metal alloys. The blades 16,17,18,19 are made of steel, cast-iron, or other suitable metal alloys. The blades 16,17,18,19 are spaced equally around the axis of the hub 20 and welded, soldered, or mechanically fastened in place.

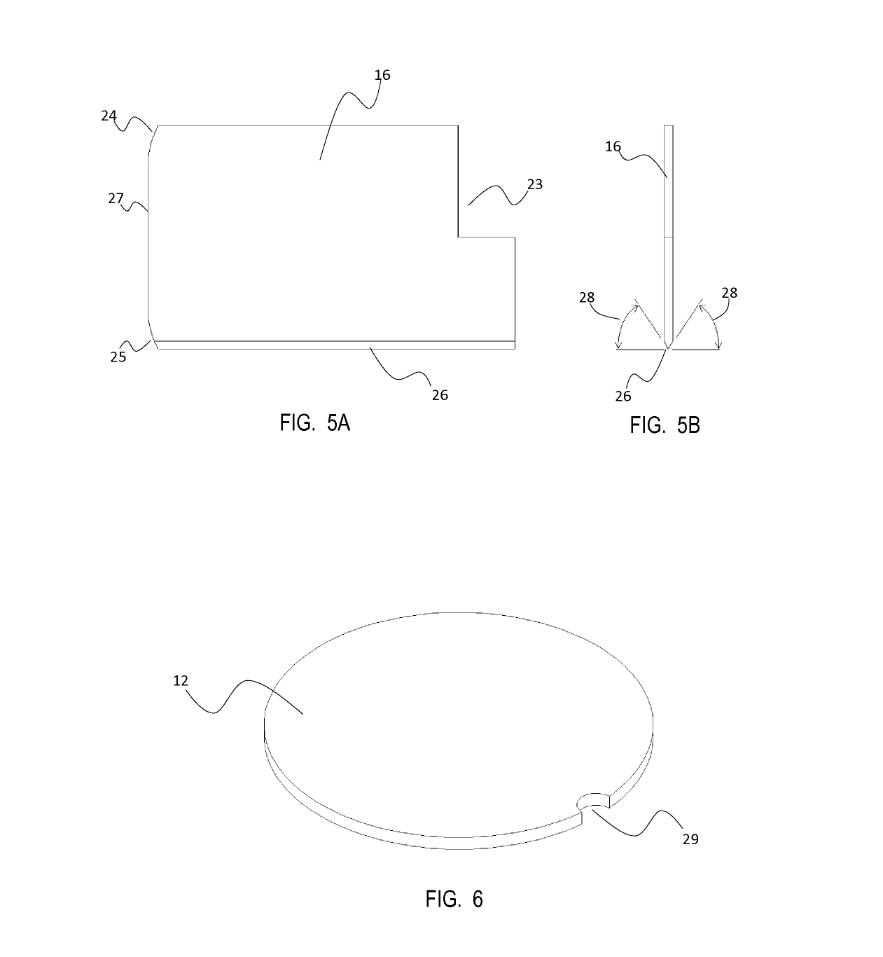

FIG. 5A is the front view of a chopping blade 16. The blade has a straight notch 23, an upper curved edge 24, a lower curved edge 25, an outside edge 27, and a sharpened edge 26. The straight notch 23 has a length sized to fit half of the diameter of the hub 20 and a height of sufficient size to provide rigid vertical support of the blade 16. The upper curved edge 24 and lower curved edge 25 are tangent to the outer edge 27 of the blade 16. This allows the blade 16 to smoothly slide up and down the interior wall of the containment vessel 13 without grabbing or causing damage. The sharpened edge 26 follows the complete length of the bottom edge of the blade 16.

FIG. 5B is an edge view of the chopping blade 16. The sharpened edge 26 comes to a point at the center of the thickness of the chopping blade 16. The sharpened edge 26 is shaped to an angle 28. The angle 28 allows easy chopping of the organic material and a strong, lasting sharpened edge 26.

FIG. 6 is a perspective view of one embodiment of the chopping board 12 of FIG. 1. The chopping board 12 is made of plastic or other suitable high-impact material that is not hard enough to dull or damage the chopping blades 16,17,18,19. The chopping board 12 is cut to match the inside shape (a circle in this embodiment) of the containment vessel 13. A notch 29 is cut at a point along the circumference of the chopping board 12 to allow the easy insertion and removal of the chopping board 12 within the containment vessel 13. The chopping board 12 has a predetermined thickness to allow suitable durability and rigidity during use.

### Operation—First Embodiment—FIGS. 1, 2, 3

The following steps are necessary to utilize the preferred embodiment of this system.
1) The user places the containment vessel 13 on flat and stable ground.
2) The chopping board 12 is placed into the containment vessel 13.
3) The organic matter 14 is placed into the containment vessel 13, on top of the chopping board 12.
4) The chopping device 11 is firmly grasped by the handle 15 and lowered into the containment vessel 13.
5) With quick and firm strokes, the chopping device 11 is thrust downward onto the chopping board 12, chopping the organic matter 14 into smaller pieces. Slight rotation of the chopping device 11 will ensure the organic matter 14 is evenly chopped.
6) When the organic matter 14 has reached desired size, the chopping device 11 is removed and the containment vessel 13 is used to transport and dump the organic matter 14 into the compost pile.
7) The chopping board 12 comes out freely when dumping the organic matter 14, or is pulled out with a finger using the notch 29.

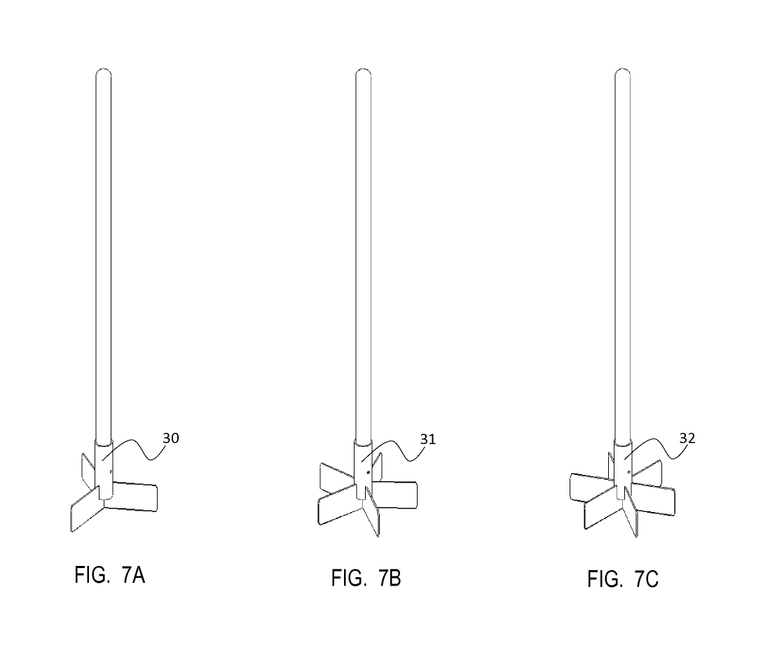

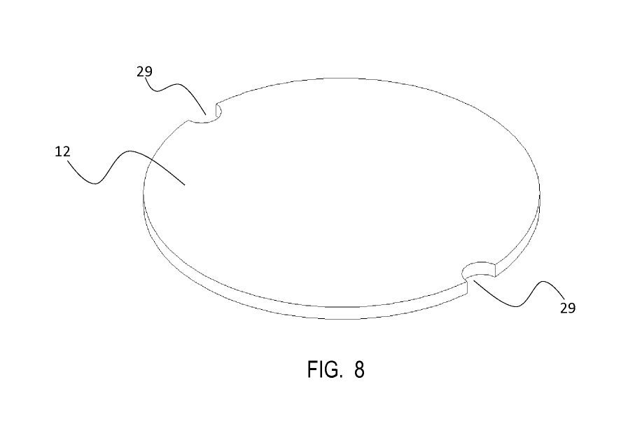

### Alternate Embodiments—FIGS. 7A, 7B, 7C, 8

FIGS. 7A through 7C shows alternate embodiments of the chopping device 11 of FIG. 1. FIG. 7A shows an embodiment of a three blade chopping device 30. FIG. 7B shows an embodiment of a five blade chopping device 31. FIG. 7C shows an embodiment containing a six blade chopping device 32.

FIG. 8 shows an alternate embodiment of the chopping board 12 of FIG. 1. This embodiment incorporates a notch 29 in two locations along the perimeter of the chopping board 12.

### Advantages

From the description above, a number of advantages of some embodiments of the device and method of chopping organic matter become evident:
(a) The construction of the chopping device is simple and sturdy, thereby decreasing the amount of maintenance required to keep the chopping device functional.
(b) The straight handle of the chopping device allows the user to forcefully thrust the blades down to the chopping board, without undue strain to the user.
(c) Since the chopping device's blades extend to all edges of the chopping board, more organic matter is chopped with each downward stroke of the chopping device.
(d) Because the blades of the chopping device have curved corners, if the blades come into contact with the sides of the containment vessel during use, the blades will not damage the inside of the containment vessel.
(e) Because the chopping device's handle, the chopping blades, the chopping board, and the chopping vessel are all concentric around one axis, the user can easily manipulate the handle of the chopping device, through rotation about the axis, thereby ensuring all organic matter is chopped evenly.
(f) The chopping board provides a flat and firm surface, which facilitates fast and easy chopping while protecting the bottom surface of the containment vessel.
(g) The chopping board conforms to the inside shape of the bottom of the containment vessel, thereby ensuring that all organic matter is contained on top of the chopping board during use.
(h) The notches in the chopping board facilitate removal of the chopping board for easy cleaning of all components.
(i) The containment vessel has an open top providing a clear view inside during chopping, thereby helping the user determine when the appropriate size of chopped pieces has been attained.

### CONCLUSIONS, RAMIFICATIONS, AND SCOPE

Accordingly, the reader can see that the device and method for chopping organic matter can be used to easily, efficiently, and consistently chop organic matter prior to introduction to a compost bin or compost pile. The chopping device works together with the chopping board and the containment vessel to provide a very simple and robust method of chopping. Furthermore, the device and method for chopping organic matter has the additional advantages in that:
it produces consistent and clean chops of the organic matter, which aid in increasing the effectiveness and efficiency of the composting process;
it provides a neat and easy method of containment, chopping, and transport of the organic matter;
it permits the user to chop organic matter prior to introduction to compost bins, which are often constructed in a way that prohibits chopping once organic matter is already introduced;
it permits the user to have complete control over the size of the pieces of chopped organic matter.

Although the foregoing written description contains many specificities, these should not be construed as limiting the scope of the embodiments but as merely providing illustrations of some of the presently preferred embodiments. Many other variations are possible, for example:
the size of the chopping device, the chopping board and the containment vessel can be scaled up or down;
the size of the chopping device and the chopping board can be scaled in relation to the size of a predetermined containment vessel;
the blades of the chopping device can be made in an alternate shape, such as rounded, triangular, trapezoidal, etc., as long as the bottom edge of the blade retains its characteristics.
the blades can be cut, stamped, or cast;
the hub and blades could be cast or stamped together as one piece;
the notch in the chopping board could have other shapes, such as oval, rectangular, trapezoidal, etc.;
the chopping device and the chopping board may be used independent of the containment vessel and still facilitate chopping of organic matter, though advantages of using the containment vessel will be lost;
the chopping device may be used independent of both the chopping board and the containment vessel and will still facilitate chopping of organic matter, though advantages of using the chopping board and the containment vessel will be lost.

Those of ordinary skill will understand and appreciate the existence of these and other variations, combinations, and equivalents of the specific embodiments, method, and examples herein.

Thus, the scope of the embodiments should be determined by the appended claims and their legal equivalents, rather than by the examples given.

I/We claim:

1. A composting tool, comprising:
a. a handle of sufficient size to accommodate use by a human being in an upright position
b. a plurality of blades of equal size and equal shape with the bottom edge of said blades having a sharpened edge
c. a means for joining said blades at one end of said handle perpendicular to the length of said handle so said blades surround said handle's axis evenly and orient said sharpened edges downward.

2. The composting tool of claim 1 wherein said handle is elongated whereby a human being can use said composting tool in a standing position.

3. The composting tool of claim 1 wherein said blades are composed of flat steel of predetermined thickness.

4. The composting tool of claim 1 wherein said blades have shaped outside corners whereby said shaped outside corners prevent damage to the inside of said containment vessel.

5. The composting tool of claim 4 wherein said shaped outside corners are rounded.

6. The composting tool of claim 1 wherein said means of joining said blades to said handle is comprised of a steel tube welded to said blades and mechanically fastened to said handle.

7. The composting tool of claim 1 wherein said blades and said means of joining said blades are combined as a plurality of stamped steel parts mechanically fastened to said handle.

8. The composting tool of claim 1 wherein said blades and said means of joining said blades are combined into a single cast iron assembly mechanically fastened to said handle.

9. A chopping board, comprising:
a. a material of predetermined thickness and strength to withstand repeated impacts of said blades
b. a shape of said material conforming to the inside bottom of a containment vessel of predetermined size
c. a means of removing said chopping board from said containment vessel.

10. The chopping board of claim 9 wherein said shape is a circle.

11. The chopping board of claim 10 wherein said shape conforms to the inside bottom surface of a standard 5-gallon pail.

12. The chopping board of claim 10 wherein said shape conforms to the inside bottom surface of a standard 1-gallon pail.

13. The chopping board of claim 9 wherein said material is polypropylene.

14. The chopping board of claim 9 wherein said means of removing said shape is a single notch of predetermined size on the perimeter of said shape.

15. The chopping board of claim 9 wherein said means of removing said shape includes a plurality of notches of predetermined size on the perimeter of said shape.

16. A method of chopping organic matter, comprising:
a. providing a containment vessel of predetermined size
b. providing a chopping board and inserting said chopping board into said containment vessel
c. providing said organic matter and inserting said organic matter into said containment vessel so that said organic matter rests on-top of said chopping board
d. providing a composting tool and inserting said composting tool into said containment vessel so that said composting tool is positioned above said organic matter
e. thrusting said composting tool firmly downward so that said composting tool chops through said organic matter and contacts the top surface of said chopping board
f. repeating said thrusting movement until said organic matter is of desired chopped size
g. removing said composting tool from said containment vessel
h. removing said organic matter from said containment vessel
whereby said organic matter is now chopped and can be easily added to compost.

17. The method of claim 16 wherein said containment vessel is a standard 5-gallon pail.

18. The method of claim 16 wherein said containment vessel is a standard 1-gallon pail.
